(19) United States
(12) Patent Application Publication
(10) Pub. No.: US 2025/0045725 A1
(43) Pub. Date: Feb. 6, 2025

(54) Ad Hoc and Touchless Commerce System Over Short Range Radio Frequencies

(71) Applicant: BAM Enterprises of Amarillo, LLC, Amarillo, TX (US)

(72) Inventors: Bradley Veazey, Amarillo, TX (US); Eduardo Fragoso, Amarillo, TX (US); Martin Lewis, Plainview, TX (US)

(21) Appl. No.: 18/709,134

(22) PCT Filed: Nov. 14, 2022
(86) PCT No.: PCT/US22/79845

§ 371 Date: May 10, 2024

Related U.S. Application Data
(60) Provisional application No. 63/375,457, filed on Sep. 13, 2022.
(60) Provisional application No. 63/369,593, filed on Jul. 27, 2022.
(60) Provisional application No. 63/278,393, filed on Nov. 11, 2021.

(51) Int. Cl. G06Q 20/32; G06Q 20/20; G06Q 20/38; G06Q 20/40; G06Q 30/0601

(52) U.S. Cl. CPC G06Q 20/327; G06Q 20/20; G06Q 20/388; G06Q 20/40145; G06Q 30/0633

(57) ABSTRACT

A method of use of a commercial transaction system for establishing a secure transaction between a point of sale system and a customer device and verifying the identity of a merchant and one or more consumers is disclosed. Comprising establishing a merchant account and merchant beacon ID with SS application associated with the merchant. establishing a transaction start request between a transaction parties comprising the merchant and a current customer among the one or more consumers. creating a transaction data package on the SS application of a sales system server comprising at least transaction ID, a shopping cart and a shopping limitations parameters. sending a portion of the transaction data package to CD application.

### CROSS-REFERENCE TO RELATED APPLICATIONS

This application claims the benefit of PCT/US22/79845, filed on Nov. 14, 2022. The PCT application claims priority to three U.S. Provisional Applications: No. 63/278,393, filed on Nov. 11, 2021; No. 63/369,593, filed on Jul. 27, 2022; and No. 63/375,457, filed on Sep. 13, 2022. Concurrently, national phase applications under the PCT application have been filed in Mexico, numbered MX/a/2024/005640, and in Canada, numbered 3237638, both filed on May 8, 2024. Additionally, an application is anticipated to be filed in the European Patent Office within the coming month. All national phase applications claim priority to the aforementioned PCT application, which has received an International Search Opinion of fully allowable.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

It is estimated that 38 percent of all point of sale transactions in the United States are conducted using a credit card. Although merchant costs for such transactions typically fall between 2.5%-3.0%, merchants are willing to forgo this profit margin due to the convenience of conducting commerce in a purely digital manner. Advantages include fraud detection, availability of funds due to credit lines, and immediate payment. However, one disadvantage to the customer is the sharing of customer information with the merchant, such as the customer's name, bank or creditor name, and signature; all of which can go into the merchant's transaction records. Traditionally, if a customer wanted to maintain anonymity, he might instead favor using cash only for transactions. Cash, however, presents risk of theft for all parties and the added hassle of counting, depositing, and avoidance of counterfeiting.

Likewise, there are industries and products which require a merchant to know their customer under federal reserve section 601.0. Indeed, failure to know a customer according to this federal requirement can lead to criminal exposure to a merchant or institution. One purpose of the “know your customer” (“KYC”) policy should decrease the likelihood that the financial institution will become a victim of illegal activities perpetrated by its “customers.” However, the KYC requirements as published by the Federal Reserve in the Bank Secrecy Act Manual in 1997, is a 62 page document which may require the talents of a building full of tax and accounting professionals to implement.

How then, can a merchant do business in a digital manner while protecting the anonymity of his customers, meeting regulatory requirements and enabling the ease of transacting with credit cards?One purpose of a commercial transaction system 100 is to accomplish all of this.

The Applicants do not know of any relevant prior art, but examples of BLE transaction system can be found at US20150332240A1, US20160092880A1 and US20160063476A1.

Cited in the international search opinion are these applications US 2018/0314841 A1, US 2015/0332240 A1, US 2017/0255923 A1.

### BRIEF SUMMARY OF THE INVENTION

A method of use of a commercial transaction system for establishing a secure transaction between a point of sale system and a customer device and verifying the identity of a merchant and one or more consumers is disclosed. Comprising establishing a merchant account and merchant beacon ID with SS application associated with said merchant. establishing a transaction start request between a transaction parties comprising said merchant and a current customer among said one or more consumers. creating a transaction data package on said SS application of a sales system server comprising at least transaction ID, a shopping cart and a shopping limitations parameters. sending a portion of said transaction data package to CD application on said customer device of said current customer and a POS application on said point of sale system of said merchant. populating said shopping cart of said transaction data package using at least one among said CD application and said one or more consumers. verifying an identity of the transaction parties using said transaction data package. completing a transaction between the transaction parties. establishing a customer account and a customer beacon ID with said SS application and associated with said one or more consumers. activating a customer beacon on said customer device bearing said customer beacon ID. verifying said merchant and said one or more consumers to one another by matching and verifying said merchant beacon ID and said customer beacon ID using said point of sale system, said customer device and said sales system server. assigning said transaction ID to a transaction between said merchant and said one or more consumers. facilitating and verifying an ad hoc transaction between the parties on said customer device and said point of sale system. wherein establishing said transaction start request between said customer device of said current customer and said sales system server of said merchant comprises: broadcasting said customer beacon from said point of sale system comprising said merchant beacon ID, receiving said customer beacon from said point of sale system with a CD beacon hardware of said customer device, matching a CD memory of said customer device with said POS application of said point of sale system using said SS application of said sales system server, creating said transaction data package on said sales system server, synchronizing a portion of said transaction data package to said CD application and said CD application as a synchronized copy, and completing a transaction between the parties using said transaction data package.

Said method of use of said commercial transaction system for establishing a secure transaction between said point of sale system and said customer device and verifying the identity of said merchant and said one or more consumers is disclosed. Comprising establishing said merchant account and said merchant beacon ID with said SS application associated with said merchant. establishing said transaction start request between a transaction parties comprising said merchant and said current customer among said one or more consumers. creating said transaction data package on said SS application of said sales system server comprising at least said transaction ID, said shopping cart and said shopping limitations parameters. sending a portion of said transaction data package to said CD application on said customer device of said current customer and said POS application on said point of sale system of said merchant. populating said shopping cart of said transaction data package using at least one among said CD application and said one or more consumers. verifying an identity of the transaction parties using said transaction data package. completing a transaction between the transaction parties.

Said method of use of said commercial transaction system for establishing a secure transaction between said point of sale system and said customer device and verifying the identity of said merchant and said one or more consumers is disclosed. Comprising establishing said merchant account and said merchant beacon ID with said SS application associated with said merchant. establishing said transaction start request between a transaction parties comprising said merchant and said current customer among said one or more consumers. creating said transaction data package on said SS application of said sales system server comprising at least said transaction ID, said shopping cart and said shopping limitations parameters. sending a portion of said transaction data package to said CD application on said customer device of said current customer and said POS application on said point of sale system of said merchant. populating said shopping cart of said transaction data package using at least one among said CD application and said one or more consumers. verifying an identity of the transaction parties using said transaction data package. completing a transaction between the transaction parties. establishing said transaction start request between said customer device of said current customer and said sales system server of said merchant comprises: comparing a location of said customer device with a merchant location of a merchant store, verifying said customer device is in proximity of said merchant store, notifying said SS application using said CD application of said customer device of a nearness of said merchant store and said customer device, and establishing said transaction start request using said CD application of said customer device. for each said current customer among said one or more consumers: creating unique credentials associated with said current customer, collecting an identity verification database and a payment accounts database associated with said customer account of said current customer, applying a jurisdiction regulations associated with said current customer to said customer account, and associating one or more bio-verification markers with said current customer within said CD application. for each among said current customer: receiving a unique identifier associated with said current customer in said CD application, creating said transaction start request associated with said current customer and said POS application, sending said transaction start request to said SS application, sending said synchronized copy to said one or more consumers to associated said current customer with said transaction data package, and verifying the identity of said current customer.

### BRIEF DESCRIPTION OF THE SEVERAL VIEWS OF THE DRAWING

FIG. 1 illustrates a flow diagram of a commercial transaction system 100.

FIG. 2A illustrates an elevated overview of a merchant store 200 with a point of sale system 110 and a customer device 120.

FIG. 2B illustrates elevated external site plan 208 of said merchant store 200.

FIG. 3B illustrates a check-out counter 202 with a payment card transaction 302.

FIG. 3 illustrates a prior art transaction flow diagram 300.

FIG. 4 illustrates a block diagram 440 of said point of sale system 110, a sales system server 140 and said customer device 120 interacting under said commercial transaction system 100.

FIG. 5 illustrates a block diagram 520 of said sales system server 140.

FIG. 6 illustrates a block diagram 600 of said point of sale system 110, said sales system server 140 and said customer device 120 interacting under said commercial transaction system 100.

FIG. 7A illustrates a flow chart of an account setup method 412.

FIG. 7B illustrates a flow chart of a customer verification method 418.

FIG. 8 illustrates a method of use 800 of said commercial transaction system 100 comprising a plurality of steps 802.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

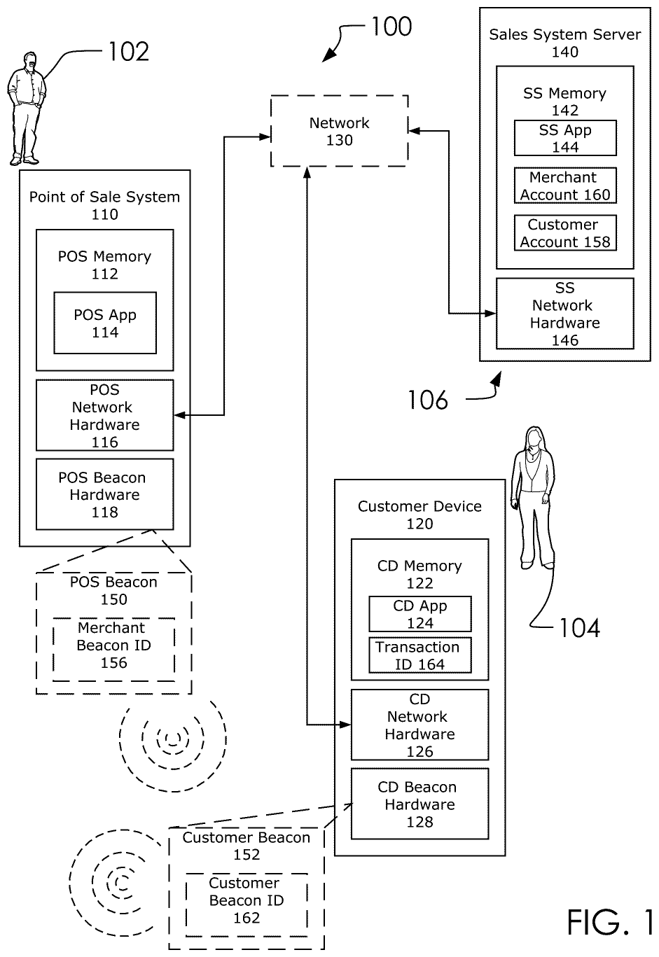

FIG. 1 illustrates a flow diagram of a commercial transaction system 100.

In one embodiment, said commercial transaction system 100 can comprise an ad hoc communication between a merchant 102, one or more consumers 104 and a sales system 106.

In one embodiment, said merchant 102 can comprise a point of sale system 110 having a POS memory 112 comprising a POS application 114, a POS network hardware 116 and a POS beacon hardware 118. Said one or more consumers 104 can each comprise a customer device 120 comprising a CD memory 122 having CD application 124, a CD network hardware 126 and a CD beacon hardware 128. In one embodiment, said point of sale system 110, said customer device 120 and said sales system 106 can communicate over a network 130. Finally, said sales system 106 can comprise a sales system server 140 having a SS memory 142 having SS application 144, and a SS network hardware 146.

Each of said POS beacon hardware 118 and said CD beacon hardware 128 can generate a beacon signal, such as a Bluetooth low energy (“BLE”) or iBeacon® (a Trademarked version of BLE developed and marketed by Apple®). said POS beacon hardware 118 can comprise a POS beacon 150 and said CD beacon hardware 128 can comprise a customer beacon 152.

In one embodiment, said commercial transaction system 100 can utilize the generation and interpretation of said POS beacon 150 and said customer beacon 152 to ensure a safe, private, secure and/or compliant digital transaction between said merchant 102 and said one or more consumers 104, known hereafter as an ad hoc transaction 154 (illustrated below). In one embodiment, said commercial transaction system 100 can utilize a communication between said point of sale system 110, said customer device 120 and said sales system server 140 to accomplish said ad hoc transaction 154.

In one embodiment, said commercial transaction system 100 can comprise said one or more consumers 104, said SS application 144, said CD application 124, a merchant account 160, and a customer account 158.

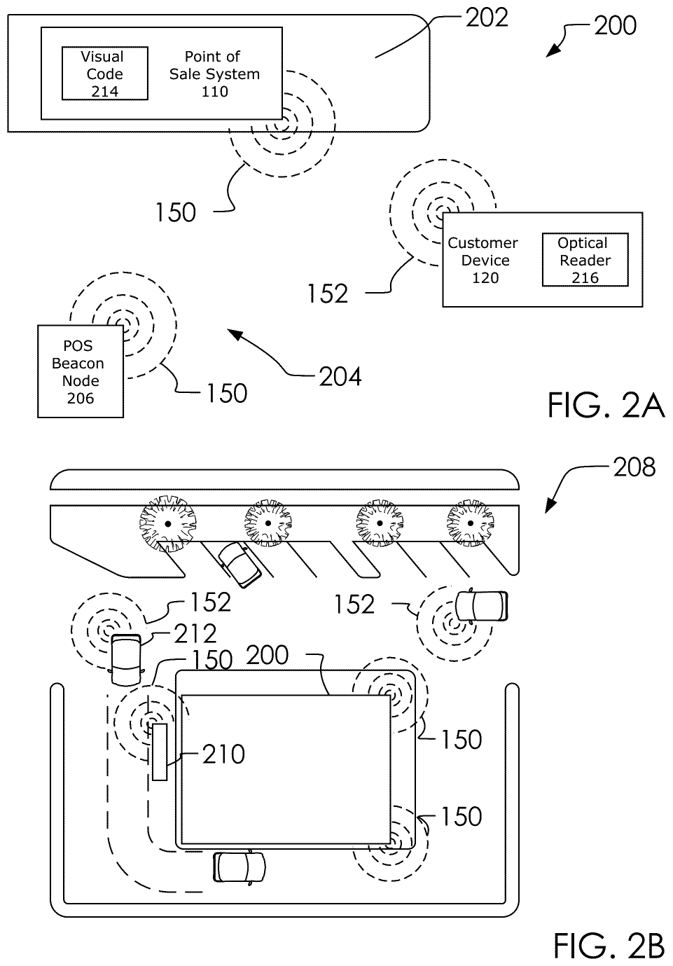

FIG. 2A illustrates an elevated overview of a merchant store 200 with said point of sale system 110 and said customer device 120.

In one embodiment, said commercial transaction system 100 can be implemented in a retail store, restaurant, or similar venue where said one or more consumers 104 and said merchant 102 would traditionally transact commerce. In one embodiment, said one or more consumers 104 can have said point of sale system 110 on a check-out counter 202; whereupon, said one or more consumers 104 would present selected merchandise for purchase, pay said merchant 102 and thereafter leave with the merchandise.

In one embodiment, said merchant store 200 can comprise one or more beacon hardware 204 in addition to and including said POS beacon hardware 118 arranged within and around said merchant store 200; whereby, said commercial transaction system 100 can calculate a proximity signal and location of said customer device 120 within said merchant store 200, as is known in the art.

In one embodiment, said merchant store 200 can comprise one or more POS beacon nodes 206 around said merchant store 200 or elevated external site plan 208 for generating said POS beacon 150.

Said one or more beacon hardware 204 can comprise said POS beacon hardware 118 and said one or more POS beacon nodes 206.

One goal of said commercial transaction system 100 is to establish said ad hoc transaction 154 between said merchant 102 and said one or more consumers 104 by the sending and receiving of said POS beacon 150 and said customer beacon 152.

In one embodiment, said one or more consumers 104 can already have installed said CD application 124 on said customer device 120 and activated said customer beacon 152 from said customer device 120. In that case, said point of sale system 110 can read said customer beacon 152 and establish a starting point for said ad hoc transaction 154 with said customer device 120.

In one embodiment, said one or more consumers 104 can set up an account with said SS application 144, including payment methods, personal records, and any and all requirements under the KYC regulations, as discussed in the Background section of this application. Whereupon, said commercial transaction system 100 can meet all regulatory requirements for said merchant 102 and said one or more consumers 104 to interact, even where said merchant 102 is not given unnecessary access to information about said one or more consumers 104. Thereby, said merchant 102 can rely on said sales system 106 to establish a known customer dossier, and focus on the quality of his merchandise, pricing and customer service.

In one embodiment, said customer beacon 152 can be turned off when said one or more consumers 104 enters said merchant store 200. However, by installing said CD application 124, said CD application 124 can request and activate said customer beacon 152. In one embodiment, said CD application 124 can operate with a plurality of merchants and thereby enable said one or more consumers 104 to gain the benefits of said commercial transaction system 100 without installing a plurality of apps on said customer device 120.

In one embodiment, said merchant 102 can collect shopping data such as time spent in said merchant store 200, location within said merchant store 200, items considered, and transaction total, all without gathering personally identifiable information about said one or more consumers 104. Thereby, said merchant 102 can improve his store without invading the privacy of said one or more consumers 104.

In one embodiment, said point of sale system 110 can comprise a visual code 214 which can be read by an optical reader 216 of said customer device 120. Said visual code 214 can comprise a QR code and said optical reader 216 can comprise a camera.

FIG. 2B illustrates said elevated external site plan 208 of said merchant store 200.

In many modern American companies, said merchant store 200 can comprise external features, such as a drive through kiosk 210. Whereupon, said commercial transaction system 100 can be used to establish and confirm transactions between said merchant 102 in said merchant store 200 and said one or more consumers 104 in a vehicle 212. In one embodiment, said one or more consumers 104 can activate said CD application 124 within said vehicle 212, and thereby broadcast said customer beacon 152, as illustrated.

As illustrated, said commercial transaction system 100 can be equipped to confirm the location of said one or more consumers 104 by triangulating the location of said customer beacon 152 as between said one or more POS beacon nodes 206. Thereby, said merchant 102 can confirm the location and presence of a customer and identify said ad hoc transaction 154 with one among a plurality of customers. As illustrated in said elevated external site plan 208, a plurality of said vehicle 212 can be located around said elevated external site plan 208 and move near, and past said drive through kiosk 210. One advantage of said commercial transaction system 100 is to identify customers in a real world 3D space while maintaining the privacy of said one or more consumers 104.

In one embodiment, said CD application 124 can activate a GPS or other communication device to verify the location of said one or more consumers 104 and said point of sale system 110, as is known in the art. Such signals can enhance said commercial transaction system 100 and the interaction between said merchant 102 and said one or more consumers 104.

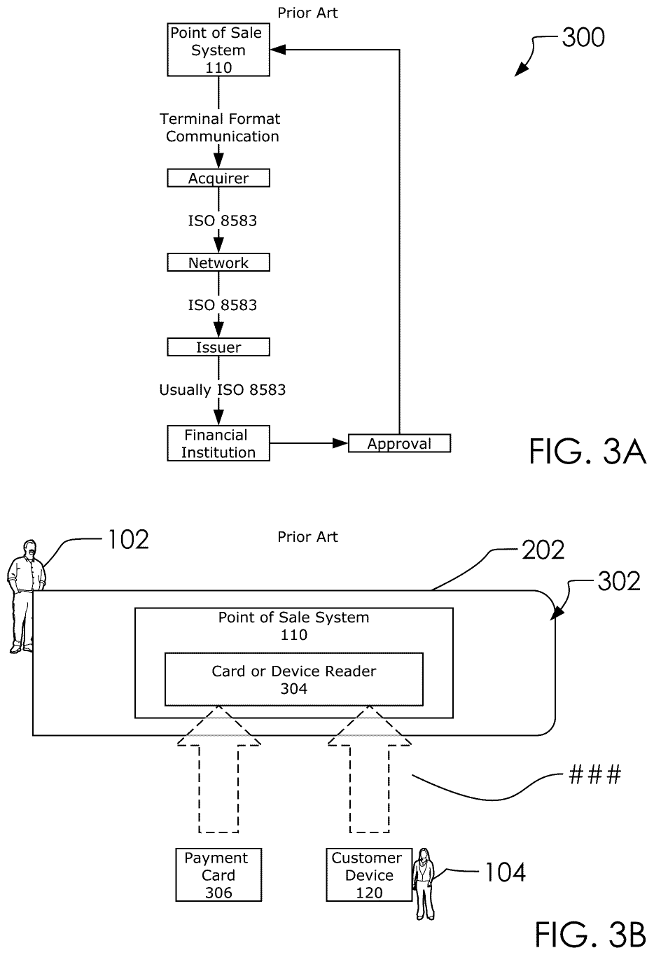

FIG. 3B illustrates said check-out counter 202 with a payment card transaction 302.

Likewise, said merchant store 200 is ill-equipped to manage complex transactions in the KYC space. Consider a card-device reader in said point of sale system 110, as is known in the art, in order for a user to interact with a card-device reader 304, a localized data transfer between said point of sale system 110 and said customer device 120 or a payment card 306 must be transacted. a localized data transfer can comprise a magnetic card read or chip read from a payment card, or similar transfer from said customer device 120. Wherein, a payment card represents a data vulnerability where fraud and theft can occur, victimizing said merchant 102 or said one or more consumers 104.

Accordingly, said commercial transaction system 100 can be configured to establish a verifiable relationship between said merchant 102 and said one or more consumers 104, to maintain a regulatory KYC paper trail, and clear transactions without data vulnerability in a localized data transfer.

FIG. 3 illustrates a prior art transaction flow diagram 300.

In one embodiment, said prior art transaction flow diagram 300 can describe the path of clearing a transaction from said point of sale system 110 to an acquirer, to a clearing network, to an issuer, to a financial institution, and then the return trip of the approval to said point of sale system 110. In said prior art transaction flow diagram 300 a transaction may circulate through a plurality of intermediaries for the sake of security and financial accountability, as is known in the art.

Although said prior art transaction flow diagram 300 is quite robust, it was not designed around the management of customers and vendors who must maintain a know your customer “KYC” relationship. An end user could easily give his credit card to a friend to purchase goods and services at a merchant, rarely does the merchant verify the identity of or signature of a customer, despite the collection of signatures.

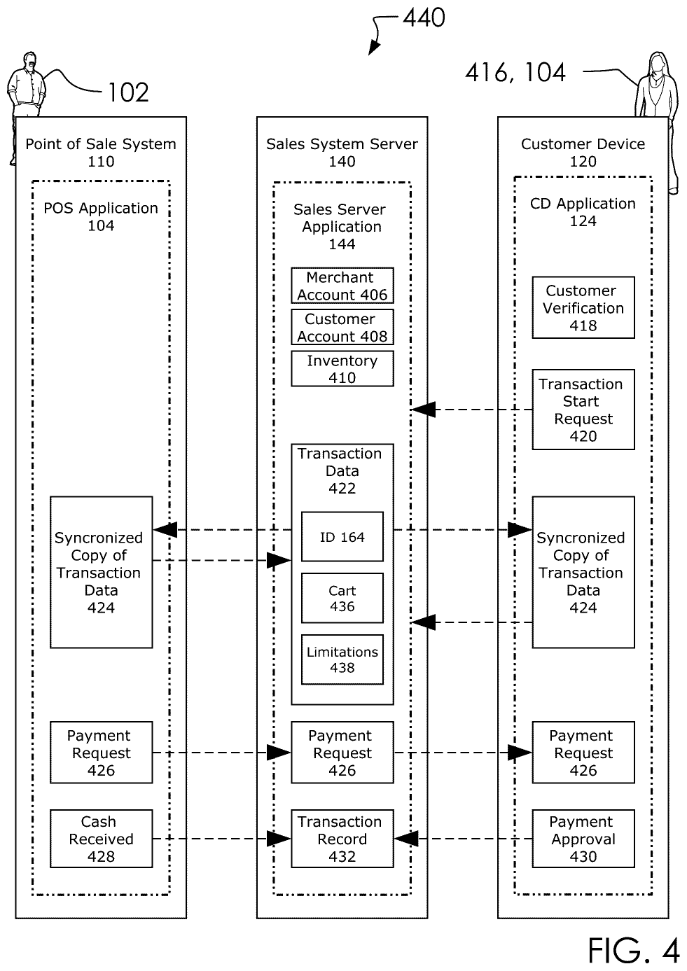

FIG. 4 illustrates a block diagram 440 of said point of sale system 110, said sales system server 140 and said customer device 120 interacting under said commercial transaction system 100.

In one embodiment, said commercial transaction system 100 can comprise said point of sale system 110 having said one or more consumers 104, said sales system server 140 having said SS application 144, and said customer device 120 having said CD application 124. As is known in the art, said CD application 124 can be installed on said merchant 102 by said one or more consumers 104 and configured to interact with said sales system server 140.

In one embodiment, said SS application 144 can be configured to maintain said merchant account 160 associated with one or more of said merchant 102 and said customer account 158 associated with said one or more consumers 104. Said merchant account 160 can maintain an inventory 410 associated with merchandise available from said merchant 102.

In one embodiment, said commercial transaction system 100 can comprise an account setup method 412 and a KYC transaction method 414, discussed and illustrated below. In one embodiment, said CD application 124 can interview said one or more consumers 104 while creating said customer account 158 according to said account setup method 412, as discussed below.

In one embodiment, said KYC transaction method 414 can comprise verifying an identity of a current customer 416 among said one or more consumers 104 using a customer verification method 418 in said CD application 124, creating a transaction start request 420 with said CD application 124 and sending said transaction start request 420 to said SS application 144, creating a transaction data package 422 with said sales system server 140 associated with a new transaction between said current customer 416 and said merchant 102, creating a synchronized copy 424 of said transaction data package 422 on said CD application 124 and said one or more consumers 104, updating said transaction data package 422 as said current customer 416 shops, initiating a payment request 426 on said one or more consumers 104 when said current customer 416 is finished shopping, transmitting said payment request 426 from said one or more consumers 104 to said SS application 144 to said CD application 124, entering either a cash received signal 428 from said one or more consumers 104 or a payment approval 430 from said CD application 124, and recording a transaction record 432 in said SS application 144.

In one embodiment, said sales system server 140 can comprise transaction ID 164, a shopping cart 436, and a shopping limitations parameters 438. In one embodiment, said transaction ID 164 can comprise a unique identifier of said transaction data package 422, and said shopping cart 436 can comprise a list of merchandise purchased by said current customer 416. Said shopping limitations parameters 438 can comprise a list of limitations on purchases by said current customer 416, such as regulatory limits on purchasing. In one embodiment, said shopping limitations parameters 438 can be tied to a state limitation on drug purchasing by a user in a given time, such as a day, week, month, or year. In one embodiment, said commercial transaction system 100 can be configured to update said shopping limitations parameters 438 based on past purchases by said current customer 416 at one or more among said merchant 102.

In one embodiment, said inventory 410 can be maintained based on inputs from said merchant 102 and sales collected in said transaction record 432.

In one embodiment, said transaction ID 164 and said transaction start request 420 can be created automatically when said point of sale system 110 or said CD beacon hardware 128 establish contact with one another.

By moving said payment approval 430 away from a localized data transfer, said commercial transaction system 100 is configured to eliminate a data vulnerability between said customer device 120, said payment card 306 and said card-device reader 304.

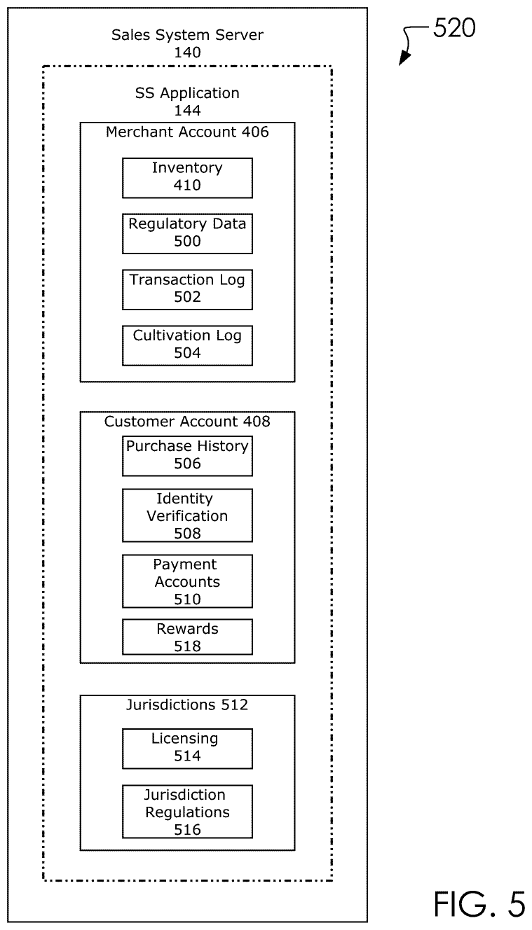

FIG. 5 illustrates a block diagram 520 of said sales system server 140.

In one embodiment, said merchant account 160 can comprise said inventory 410, a regulatory database 500, a transaction log 502, and a cultivation log 504. Wherein, said regulatory database 500 can comprise a set of rules associated with said merchant 102 in its jurisdiction. Said transaction log 502 can comprise a database of said transaction record 432 having been previously recorded. Said cultivation log 504 can comprise a record of merchandise being grown by or for said merchant 102.

Each said one or more consumers 104 can comprise a set of records in said customer account 158 associated with their interactions with said commercial transaction system 100. Said customer account 158 can comprise a purchase history 506, an identity verification database 508, and a payment accounts database 510. Said identity verification database 508 can comprise a set of records associated with KYC requirements.

In one embodiment, said sales system server 140 can further comprise a jurisdiction database 512. In one embodiment, said commercial transaction system 100 can be configured to maintain a set of requirements associated with locations and governing authority over said merchant 102. One such regulatory environment can comprise a state legislator and its regulatory environment. Wherein, said commercial transaction system 100 can maintain growing rules, allotment tracking, inventory rules, sales limitations, and similar, which said merchant 102 should maintain a paper trail. Said jurisdiction database 512 can comprise a licensing requirements 514 and a jurisdiction regulations 516. In one embodiment, said commercial transaction system 100 can verify the legality of said transaction data package 422 and update said shopping limitations parameters 438 by referring to said licensing requirements 514, and said jurisdiction regulations 516.

Another example of data tracked in said jurisdiction database 512 can comprise Patriot Act requirements, FinCEN, OFAC and Cole Memorandum requirements. Likewise, due diligence requirements under KYC rules can comprise registered money services businesses, encryption standards, identity verification for said merchant 102 and said one or more consumers 104, bank secrecy act and FinCEN. Additionally, controlled substances regulations such as HIPAA, DEA regulations, looping prevention and allotments, can be managed by said commercial transaction system 100.

In one embodiment, said customer account 158 can comprise a customer rewards account 518 such as a customer loyalty program, or similar, as is known in the art.

In one embodiment, said payment accounts database 510 can comprise a gift cart balance, credit, coupons, or similar.

One advantage of said commercial transaction system 100 is the elimination of a third-party processor, as seen in said prior art transaction flow diagram 300.

In one embodiment, said customer account 158 can be set up by said SS application 144 and said CD application 124 with inputs from said one or more consumers 104. Wherein, said commercial transaction system 100 can be configured to collect data with reference to said jurisdiction database 512, maintain privacy and said jurisdiction regulations 516, as discussed herein.

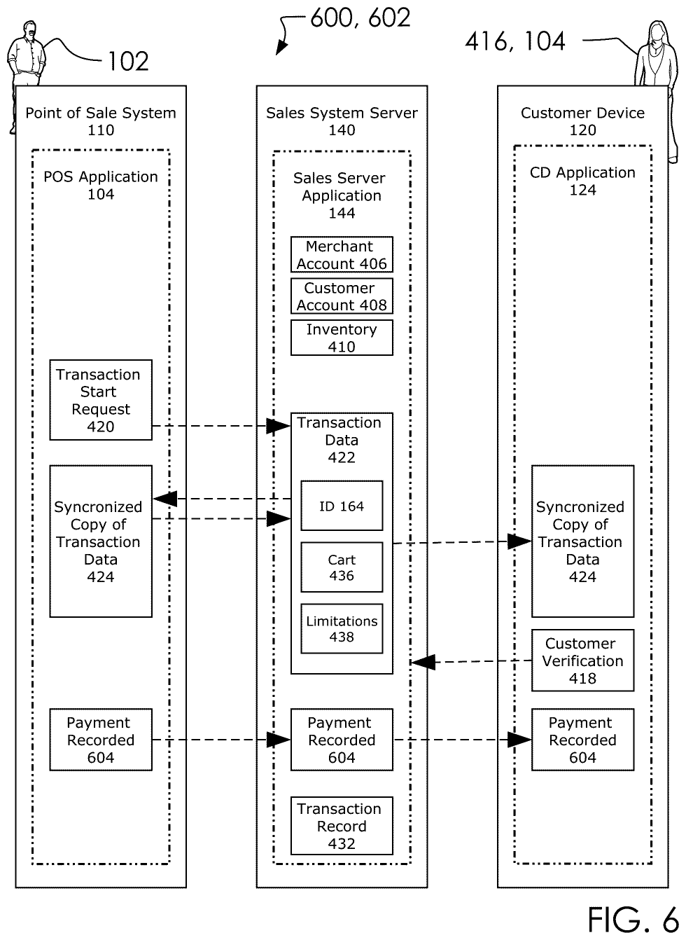

FIG. 6 illustrates a block diagram 600 of said point of sale system 110, said sales system server 140 and said customer device 120 interacting under said commercial transaction system 100.

Said block diagram 600 can further illustrate a transaction method 602 and a payment record 604.

In one embodiment, said commercial transaction system 100 can comprise said point of sale system 110 having said one or more consumers 104, said sales system server 140 having said SS application 144, and said customer device 120 having said CD application 124. As is known in the art, said CD application 124 can be installed on said merchant 102 by said one or more consumers 104 and configured to interact with said sales system server 140.

In one embodiment, said SS application 144 can be configured to maintain said merchant account 160 associated with one or more of said merchant 102 and said customer account 158 associated with said one or more consumers 104. Said merchant account 160 can maintain said inventory 410 associated with merchandise available from said merchant 102.

In one embodiment, said commercial transaction system 100 can comprise said account setup method 412 and said KYC transaction method 414, illustrated and discussed below. For example, said CD application 124 can interview said one or more consumers 104 while creating said customer account 158 according to said account setup method 412, as discussed below.

In one embodiment, said transaction method 602 for using said commercial transaction system 100 can comprise: establishing said transaction start request 420 with said one or more consumers 104, passing said transaction start request 420 to said SS application 144 of said sales system server 140, creating said transaction data package 422 with said SS application 144, maintaining said synchronized copy 424 on said one or more consumers 104 related to said transaction data package 422, updating said synchronized copy 424 and said transaction data package 422 with items to be purchased by said current customer 416, updating said shopping cart 436 according to limitations in said shopping limitations parameters 438 of said transaction data package 422, sending a portion of said synchronized copy 424 to said CD application 124 of said customer device 120, receiving said customer verification method 418 from said CD application 124, and concluding a transaction based on said transaction data package 422 and said synchronized copy 424.

Concluding said transaction data package 422 can comprise recording a cash payment from said current customer 416 by said merchant 102, debiting said customer account 158 and crediting said merchant account 160, or similar as is known in the art. Wherein, said payment record 604 can be added to said one or more consumers 104, said SS application 144 and said CD application 124 and recorded as said transaction record 432 in said SS application 144.

In one embodiment, said sales system server 140 can comprise said transaction ID 164, said shopping cart 436, and said shopping limitations parameters 438. In one embodiment, said transaction ID 164 can comprise a unique identifier of said transaction data package 422, and said shopping cart 436 can comprise a list of merchandise purchased by said current customer 416. Said shopping limitations parameters 438 can comprise a list of limitations on purchases by said current customer 416, such as regulatory limits on purchasing. In one embodiment, said shopping limitations parameters 438 can be tied to a state limitation on drug purchasing by a user in a given time, such as a day, week, month, or year. In one embodiment, said commercial transaction system 100 can be configured to update said shopping limitations parameters 438 based on past purchases by said current customer 416 at one or more among said merchant 102.

In one embodiment, said inventory 410 can be maintained based on inputs from said merchant 102 and sales collected in said transaction record 432.

In one embodiment, said transaction ID 164 and said transaction start request 420 can be created automatically when said point of sale system 110 or said CD beacon hardware 128 establish contact with one another.

By moving said payment approval 430 away from said localized data transfer, said commercial transaction system 100 is configured to eliminate a data vulnerability between said customer device 120, said payment card 306 and said card-device reader 304.

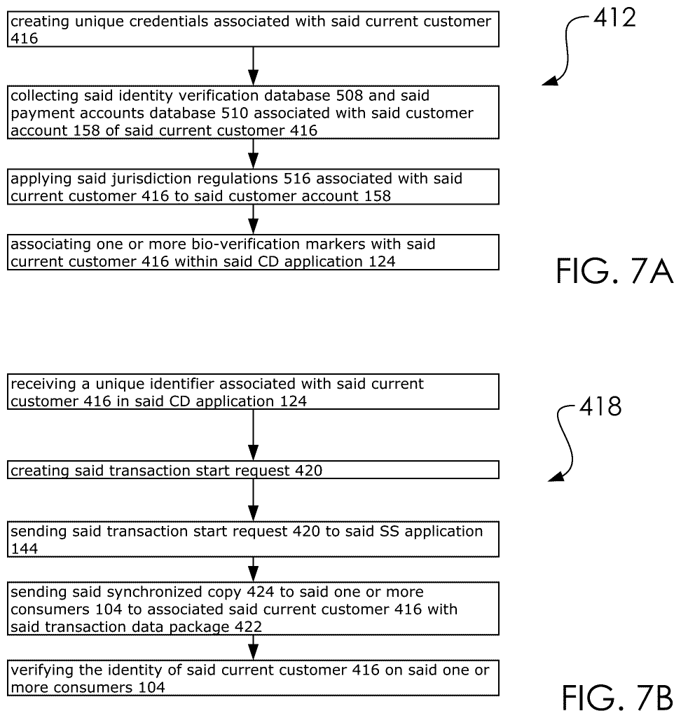

FIG. 7A illustrates a flow chart of said account setup method 412.

In one embodiment, said account setup method 412 can comprise, for each said current customer 416 among said one or more consumers 104, creating unique credentials associated with said current customer 416, collecting said identity verification database 508 and said payment accounts database 510 associated with said customer account 158 of said current customer 416, applying said jurisdiction regulations 516 associated with said current customer 416 to said customer account 158, and associating one or more bio-verification markers with said current customer 416 within said CD application 124. Wherein, said one or more bio-verification markers can comprise fingerprints, facial recognition, voice verification, or similar.

FIG. 7B illustrates a flow chart of said customer verification method 418.

In one embodiment, said customer verification method 418 can comprise receiving a unique identifier associated with said current customer 416 in said CD application 124, creating said transaction start request 420, sending said transaction start request 420 to said SS application 144, sending said synchronized copy 424 to said one or more consumers 104 to associated said current customer 416 with said transaction data package 422, and verifying the identity of said current customer 416 on said one or more consumers 104.

In one embodiment, said customer verification method 418 can comprise comparing a fingerprint or facial recognition of said current customer 416 with a record stored on said customer device 120. In one embodiment, a picture of said current customer 416 can be associated with said synchronized copy 424 and shown said one or more consumers 104 to compare with the customer in said merchant store 200 and further verify the identity of said current customer 416.

In one embodiment, said commercial transaction system 100 can establish said customer verification method 418 and said transaction start request 420 by asking said current customer 416 to check-in to said CD application 124 upon arrival at said merchant store 200. In one embodiment, said point of sale system 110 can trigger the check-in request. Said CD application 124 can be configured to suggest items, promotions, or similar to said current customer 416 when checking into said CD application 124.

In one embodiment, said commercial transaction system 100 can further comprise a newsfeed comprising sales, promotions, news, and entertainment related to said merchant 102 and said one or more consumers 104.

In one embodiment, since said commercial transaction system 100 has met all KYC regulations, promotional messages are permissible, where they are not when using SMS, email or other unverified communications.

In one embodiment, said commercial transaction system 100 can be configured to operate directly between said CD application 124 and said one or more consumers 104 when said SS application 144 is unavailable or undesirable. Wherein, said one or more consumers 104 can create said transaction data package 422, verify said shopping limitations parameters 438, maintain said synchronized copy 424 with said CD application 124, and record said transaction record 432 after said cash received signal 428 or said payment approval 430 have occurred.

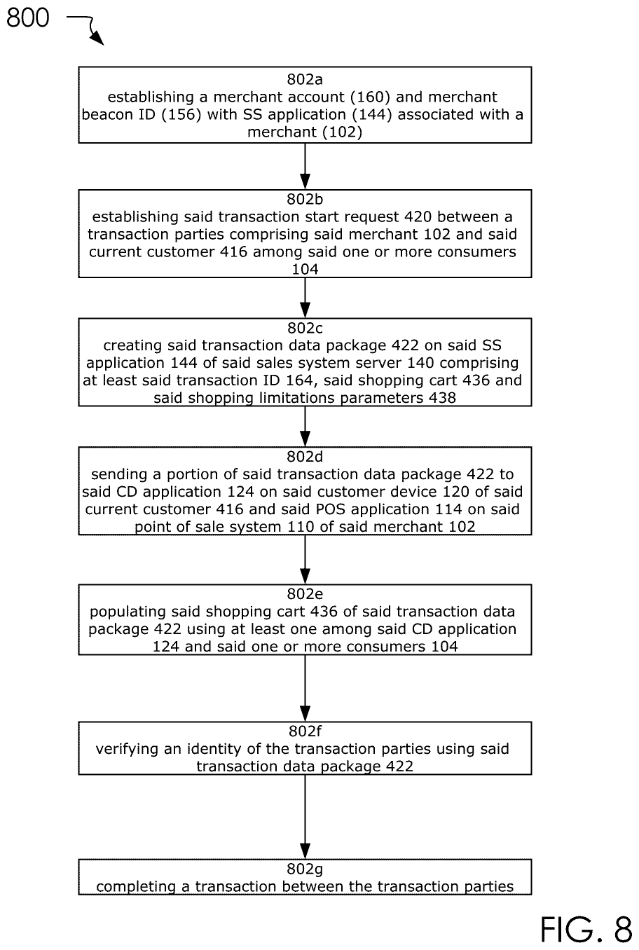

FIG. 8 illustrates a method of use 800 of said commercial transaction system 100 comprising a plurality of steps 802.

Said plurality of steps 802 of said method of use 800 of said commercial transaction system 100 can comprise: establishing said merchant account 160 and merchant beacon ID 156 with said SS application 144 associated with said merchant 102; establishing said transaction start request 420 between a transaction parties comprising said merchant 102 and said current customer 416 among said one or more consumers 104; creating said transaction data package 422 on said SS application 144 of said sales system server 140 comprising at least said transaction ID 164, said shopping cart 436 and said shopping limitations parameters 438; sending a portion of said transaction data package 422 to said CD application 124 on said customer device 120 of said current customer 416 and said POS application 114 on said point of sale system 110 of said merchant 102; populating said shopping cart 436 of said transaction data package 422 using at least one among said CD application 124 and said one or more consumers 104; verifying an identity of the transaction parties using said transaction data package 422; and completing a transaction between the transaction parties.

In another embodiment, said method of use 800 of said commercial transaction system 100 can comprise said plurality of steps 802. In one embodiment, said plurality of steps 802 can comprise establishing said merchant account 160 and said merchant beacon ID 156 with said SS application 144 associated with said merchant 102; establishing said customer account 158 and a customer beacon ID 162 with said SS application 144 associated with said one or more consumers 104; communicating between said customer device 120 and said sales system server 140 using said network 130; communicating between said point of sale system 110 and said sales system server 140 using said network 130; activating said POS beacon 150 on said one or more POS beacon nodes 206 bearing said merchant beacon ID 156; activating said customer beacon 152 on said customer device 120 bearing said customer beacon ID 162; verifying said merchant 102 and said one or more consumers 104 to one another by matching and verifying said merchant beacon ID 156 and said customer beacon ID 162 using said point of sale system 110, said customer device 120 and said sales system server 140; assigning said transaction ID 164 to a transaction between said merchant 102 and said one or more consumers 104; and facilitating and verifying said ad hoc transaction 154 between the parties on said customer device 120 and said point of sale system 110.

Variations on said method of use 800 and one preferred embodiment can comprise the following as associated with the original claims.

Said method of use 800 of said commercial transaction system 100 for establishing a secure transaction between said point of sale system 110 and said customer device 120 and verifying the identity of said merchant 102 and said one or more consumers 104 can comprise establishing said merchant account 160 and said merchant beacon ID 156 with said SS application 144 associated with said merchant 102. Establishing said transaction start request 420 between a transaction parties comprising said merchant 102 and said current customer 416 among said one or more consumers 104. Creating said transaction data package 422 on said SS application 144 of said sales system server 140 comprising at least said transaction ID 164, said shopping cart 436 and said shopping limitations parameters 438. Sending a portion of said transaction data package 422 to said CD application 124 on said customer device 120 of said current customer 416 and said POS application 114 on said point of sale system 110 of said merchant 102. Populating said shopping cart 436 of said transaction data package 422 using at least one among said CD application 124 and said one or more consumers 104. Verifying an identity of the transaction parties using said transaction data package 422. Completing a transaction between the transaction parties. Establishing said customer account 158 and said customer beacon ID 162 with said SS application 144 and associated with said one or more consumers 104. Activating said customer beacon 152 on said customer device 120 bearing said customer beacon ID 162. Verifying said merchant 102 and said one or more consumers 104 to one another by matching and verifying said merchant beacon ID 156 and said customer beacon ID 162 using said point of sale system 110, said customer device 120 and said sales system server 140. Assigning said transaction ID 164 to a transaction between said merchant 102 and said one or more consumers 104. Facilitating and verifying said ad hoc transaction 154 between the parties on said customer device 120 and said point of sale system 110. Wherein establishing said transaction start request 420 between said customer device 120 of said current customer 416 and said sales system server 140 of said merchant 102 comprises: broadcasting said customer beacon 152 from said point of sale system 110 comprising said merchant beacon ID 156, receiving said customer beacon 152 from said point of sale system 110 with said CD beacon hardware 128 of said customer device 120, matching said CD memory 122 of said customer device 120 with said POS application 114 of said point of sale system 110 using said SS application 144 of said sales system server 140, creating said transaction data package 422 on said sales system server 140, synchronizing a portion of said transaction data package 422 to said CD application 124 and said CD application 124 as said synchronized copy 424, and completing a transaction between the parties using said transaction data package 422.

Said method of use 800 of said commercial transaction system 100 for establishing a secure transaction between said point of sale system 110 and said customer device 120 and verifying the identity of said merchant 102 and said one or more consumers 104 can comprise establishing said merchant account 160 and said merchant beacon ID 156 with said SS application 144 associated with said merchant 102. Establishing said transaction start request 420 between a transaction parties comprising said merchant 102 and said current customer 416 among said one or more consumers 104. Creating said transaction data package 422 on said SS application 144 of said sales system server 140 comprising at least said transaction ID 164, said shopping cart 436 and said shopping limitations parameters 438. Sending a portion of said transaction data package 422 to said CD application 124 on said customer device 120 of said current customer 416 and said POS application 114 on said point of sale system 110 of said merchant 102. Populating said shopping cart 436 of said transaction data package 422 using at least one among said CD application 124 and said one or more consumers 104. Verifying an identity of the transaction parties using said transaction data package 422. Completing a transaction between the transaction parties. Establishing said customer account 158 and said customer beacon ID 162 with said SS application 144 and associated with said one or more consumers 104. Activating said customer beacon 152 on said customer device 120 bearing said customer beacon ID 162. Verifying said merchant 102 and said one or more consumers 104 to one another by matching and verifying said merchant beacon ID 156 and said customer beacon ID 162 using said point of sale system 110, said customer device 120 and said sales system server 140. Assigning said transaction ID 164 to a transaction between said merchant 102 and said one or more consumers 104. Facilitating and verifying said ad hoc transaction 154 between the parties on said customer device 120 and said point of sale system 110. Wherein establishing said transaction start request 420 between said customer device 120 of said current customer 416 and said sales system server 140 of said merchant 102 comprises: broadcasting said customer beacon 152 from said point of sale system 110 comprising said merchant beacon ID 156, receiving said customer beacon 152 from said point of sale system 110 with said CD beacon hardware 128 of said customer device 120, matching said CD memory 122 of said customer device 120 with said POS application 114 of said point of sale system 110 using said SS application 144 of said sales system server 140, creating said transaction data package 422 on said sales system server 140, synchronizing a portion of said transaction data package 422 to said CD application 124 and said CD application 124 as said synchronized copy 424, and completing a transaction between the parties using said transaction data package 422.

Said method of use 800 of said commercial transaction system 100 for establishing a secure transaction between said point of sale system 110 and said customer device 120 and verifying the identity of said merchant 102 and said one or more consumers 104 can comprise establishing said merchant account 160 and said merchant beacon ID 156 with said SS application 144 associated with said merchant 102. Establishing said transaction start request 420 between a transaction parties comprising said merchant 102 and said current customer 416 among said one or more consumers 104. Creating said transaction data package 422 on said SS application 144 of said sales system server 140 comprising at least said transaction ID 164, said shopping cart 436 and said shopping limitations parameters 438. Sending a portion of said transaction data package 422 to said CD application 124 on said customer device 120 of said current customer 416 and said POS application 114 on said point of sale system 110 of said merchant 102. Populating said shopping cart 436 of said transaction data package 422 using at least one among said CD application 124 and said one or more consumers 104. Verifying an identity of the transaction parties using said transaction data package 422. Completing a transaction between the transaction parties.

Establishing said transaction start request 420 between said customer device 120 of said current customer 416 and said sales system server 140 of said merchant 102 comprises: broadcasting said customer beacon 152 from said point of sale system 110 comprising said merchant beacon ID 156. Receiving said customer beacon 152 from said point of sale system 110 with said CD beacon hardware 128 of said customer device 120. Matching said CD memory 122 of said customer device 120 with said POS application 114 of said point of sale system 110 using said SS application 144 of said sales system server 140, creating said transaction data package 422 on said sales system server 140, synchronizing a portion of said transaction data package 422 to said CD application 124 and said CD application 124 as said synchronized copy 424, and completing a transaction between the parties using said transaction data package 422.

Said POS beacon 150 comprises SignalR®.

Said point of sale system 110 comprises said POS beacon hardware 118 for generating said POS beacon 150. Said POS beacon 150 comprises said merchant beacon ID 156.

Said commercial transaction system 100 further comprises said one or more POS beacon nodes 206 arranged around said merchant store 200 for broadcasting said POS beacon 150 having said merchant beacon ID 156.

Establishing said customer account 158 and said customer beacon ID 162 with said SS application 144 associated with said one or more consumers 104. Activating said customer beacon 152 on said customer device 120 bearing said customer beacon ID 162, verifying said merchant 102 and said one or more consumers 104 to one another by matching and verifying said merchant beacon ID 156 and said customer beacon ID 162 using said point of sale system 110, said customer device 120 and said sales system server 140, assigning said transaction ID 164 to a transaction between said merchant 102 and said one or more consumers 104, and facilitating and verifying said ad hoc transaction 154 between the parties on said customer device 120 and said point of sale system 110.

Establishing said transaction start request 420 between said customer device 120 of said current customer 416 and said sales system server 140 of said merchant 102 comprises: comparing a location of said customer device 120 with a merchant location of said merchant store 200, verifying said customer device 120 can be in proximity of said merchant store 200, notifying said SS application 144 using said CD application 124 of said customer device 120 of a nearness of said merchant store 200 and said customer device 120, and establishing said transaction start request 420 using said CD application 124 of said customer device 120.

Establishing said transaction start request 420 between said customer device 120 of said current customer 416 and said sales system server 140 of said merchant 102 comprises: establishing said visual code 214 comprising data associated with a location of said merchant store 200, a time data, and an encrypted key, displaying said visual code 214 on said point of sale system 110 using said POS application 114, reading said visual code 214 with said optical reader 216 of said customer device 120, verifying a proximity of said customer device 120 and said point of sale system 110 using said SS application 144 to match data in said visual code 214 and said CD application 124, and verifying an identify of said one or more consumers 104 using said customer device 120.

Said account setup method 412 and said customer verification method 418. Said account setup method 412 comprises for each said current customer 416 among said one or more consumers 104: creating unique credentials associated with said current customer 416, collecting said identity verification database 508 and said payment accounts database 510 associated with said customer account 158 of said current customer 416, applying said jurisdiction regulations 516 associated with said current customer 416 to said customer account 158, and associating one or more bio-verification markers with said current customer 416 within said CD application 124. Said customer verification method 418 comprises for each among said current customer 416: receiving a unique identifier associated with said current customer 416 in said CD application 124, creating said transaction start request 420 associated with said current customer 416 and said POS application 114, sending said transaction start request 420 to said SS application 144, sending said synchronized copy 424 to said one or more consumers 104 to associated said current customer 416 with said transaction data package 422, and verifying the identity of said current customer 416.

Verifying the identity of said current customer 416 comprises biometric verification of said current customer 416 with customer credentials stored on said customer device 120.

Verifying the identity of said current customer 416 comprises biometric verification of said current customer 416 with customer credentials stored on said customer device 120 selected among: facial recognition, fingerprint verification, voice recognition, and government ID verification.

Said account setup method 412 for each said current customer 416 among said one or more consumers 104 further comprises: collecting copies of a government ID for said current customer 416, collecting medical authorization or prescriptions for purchase of regulated goods under said jurisdiction regulations 516, and verifying biometric data associated with said current customer 416 for use in verifying an identify of said current customer 416 for said transaction data package 422. Said customer verification method 418 verifying said biometric data prior to creating said transaction data package 422, said method of use 800 can be further configured to pass portions of said jurisdiction regulations 516 to said one or more consumers 104 as said shopping limitations parameters 438 to ensure regulatory compliance for a current transaction.

Said method of use 800 of said commercial transaction system 100 for establishing a secure transaction between said point of sale system 110 and said customer device 120 and verifying the identity of said merchant 102 and said one or more consumers 104 can comprise establishing said merchant account 160 and said merchant beacon ID 156 with said SS application 144 associated with said merchant 102. Establishing said transaction start request 420 between a transaction parties comprising said merchant 102 and said current customer 416 among said one or more consumers 104. Creating said transaction data package 422 on said SS application 144 of said sales system server 140 comprising at least said transaction ID 164, said shopping cart 436 and said shopping limitations parameters 438. Sending a portion of said transaction data package 422 to said CD application 124 on said customer device 120 of said current customer 416 and said POS application 114 on said point of sale system 110 of said merchant 102. Populating said shopping cart 436 of said transaction data package 422 using at least one among said CD application 124 and said one or more consumers 104. Verifying an identity of the transaction parties using said transaction data package 422. Completing a transaction between the transaction parties. Establishing said transaction start request 420 between said customer device 120 of said current customer 416 and said sales system server 140 of said merchant 102 comprises: comparing a location of said customer device 120 with a merchant location of said merchant store 200, verifying said customer device 120 can be in proximity of said merchant store 200, notifying said SS application 144 using said CD application 124 of said customer device 120 of a nearness of said merchant store 200 and said customer device 120, and establishing said transaction start request 420 using said CD application 124 of said customer device 120. For each said current customer 416 among said one or more consumers 104: creating unique credentials associated with said current customer 416, collecting said identity verification database 508 and said payment accounts database 510 associated with said customer account 158 of said current customer 416, applying said jurisdiction regulations 516 associated with said current customer 416 to said customer account 158, and associating one or more bio-verification markers with said current customer 416 within said CD application 124. For each among said current customer 416: receiving a unique identifier associated with said current customer 416 in said CD application 124, creating said transaction start request 420 associated with said current customer 416 and said POS application 114, sending said transaction start request 420 to said SS application 144, sending said synchronized copy 424 to said one or more consumers 104 to associated said current customer 416 with said transaction data package 422, and verifying the identity of said current customer 416.

Verifying the identity of said current customer 416 comprises biometric verification of said current customer 416 with customer credentials stored on said customer device 120.

Verifying the identity of said current customer 416 comprises biometric verification of said current customer 416 with customer credentials stored on said customer device 120 selected among: facial recognition, fingerprint verification, voice recognition, and government ID verification.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”
Parts List: said commercial transaction system 100, said merchant 102, said one or more consumers 104, said sales system 106, said point of sale system 110, said POS memory 112, said POS application 114, said POS network hardware 116, said POS beacon hardware 118, said customer device 120, said CD memory 122, said CD application 124, said CD network hardware 126, said CD beacon hardware 128, said network 130, said sales system server 140, said SS memory 142, said SS application 144, said SS network hardware 146, said POS beacon 150, said customer beacon 152, said ad hoc transaction 154, said merchant beacon ID 156, said customer account 158, said merchant account 160, said customer beacon ID 162, said transaction ID 164, said merchant store 200, said check-out counter 202, said one or more beacon hardware 204, said one or more POS beacon nodes 206, said elevated external site plan 208, said drive through kiosk 210, said vehicle 212, said visual code 214, said optical reader 216, said prior art transaction flow diagram 300, said payment card transaction 302, said card-device reader 304, said payment card 306, said inventory 410, said account setup method 412, said KYC transaction method 414, said current customer 416, said customer verification method 418, said transaction start request 420, said transaction data package 422, said synchronized copy 424, said payment request 426, said cash received signal 428, said payment approval 430, said transaction record 432, said shopping cart 436, said shopping limitations parameters 438, said block diagram 440, said regulatory database 500, said transaction log 502, said cultivation log 504, said purchase history 506, said identity verification database 508, said payment accounts database 510, said jurisdiction database 512, said licensing requirements 514, said jurisdiction regulations 516, said customer rewards account 518, said block diagram 520, said block diagram 600, said transaction method 602, said payment record 604, said method of use 800, and said plurality of steps 802.

1. A method of use of a commercial transaction system for establishing a secure transaction between a point of sale system and a customer device and verifying the identity of a merchant and one or more consumers, comprising:
establishing a merchant account and merchant beacon ID with SS application associated with said merchant;
establishing a transaction start request between a transaction parties comprising said merchant and a current customer among said one or more consumers;
creating a transaction data package on said SS application of a sales system server comprising at least transaction ID, a shopping cart and a shopping limitations parameters;
sending a portion of said transaction data package to CD application on said customer device of said current customer and a POS application on said point of sale system of said merchant;
populating said shopping cart of said transaction data package using at least one among said CD application and said one or more consumers;
verifying an identity of the transaction parties using said transaction data package;
completing a transaction between the transaction parties;
establishing a customer account and a customer beacon ID with said SS application and associated with said one or more consumers;
activating a customer beacon on said customer device bearing said customer beacon ID;
verifying said merchant and said one or more consumers to one another by matching and verifying said merchant beacon ID and said customer beacon ID using said point of sale system, said customer device and said sales system server;
assigning said transaction ID to a transaction between said merchant and said one or more consumers;
facilitating and verifying an ad hoc transaction between the parties on said customer device and said point of sale system;
wherein establishing said transaction start request between said customer device of said current customer and said sales system server of said merchant comprises:
broadcasting said customer beacon from said point of sale system comprising said merchant beacon ID,
receiving said customer beacon from said point of sale system with a CD beacon hardware of said customer device,
matching a CD memory of said customer device with said POS application of said point of sale system using said SS application of said sales system server, creating said transaction data package on said sales system server,
synchronizing a portion of said transaction data package to said CD application and said CD application as a synchronized copy, and
completing a transaction between the parties using said transaction data package.

2. A method of use of a commercial transaction system for establishing a secure transaction between a point of sale system and a customer device and verifying the identity of a merchant and one or more consumers, comprising:
establishing a merchant account and merchant beacon ID with SS application associated with said merchant;
establishing a transaction start request between a transaction parties comprising said merchant and a current customer among said one or more consumers;
creating a transaction data package on said SS application of a sales system server comprising at least transaction ID, a shopping cart and a shopping limitations parameters;
sending a portion of said transaction data package to CD application on said customer device of said current customer and a POS application on said point of sale system of said merchant;
populating said shopping cart of said transaction data package using at least one among said CD application and said one or more consumers;
verifying an identity of the transaction parties using said transaction data package; and
completing a transaction between the transaction parties.

3. The method of use of claim 2, wherein:
establishing said transaction start request between said customer device of said current customer and said sales system server of said merchant comprises:
broadcasting a customer beacon from said point of sale system comprising said merchant beacon ID;
receiving said customer beacon from said point of sale system with a CD beacon hardware of said customer device;
matching a CD memory of said customer device with said POS application of said point of sale system using said SS application of said sales system server,
creating said transaction data package on said sales system server,
synchronizing a portion of said transaction data package to said CD application and said CD application as a synchronized copy, and
completing a transaction between the parties using said transaction data package.

4. The method of use of claim 3, wherein:
A POS beacon comprises SignalR®.

5. The method of use of claim 3, wherein:
said point of sale system comprises A POS beacon hardware for generating said POS beacon;
said POS beacon comprises said merchant beacon ID.

6. The method of use of claim 3, further wherein:
said commercial transaction system further comprises One or more POS beacon nodes arranged around a merchant store for broadcasting said POS beacon having said merchant beacon ID.

7. The method of use of claim 3, further wherein:
establishing A customer account and a customer beacon ID with said SS application associated with said one or more consumers;
activating said customer beacon on said customer device bearing said customer beacon ID,
verifying said merchant and said one or more consumers to one another by matching and verifying said merchant beacon ID and said customer beacon ID using said point of sale system, said customer device and said sales system server,
assigning said transaction ID to a transaction between said merchant and said one or more consumers, and
facilitating and verifying an ad hoc transaction between the parties on said customer device and said point of sale system.

8. The method of use of claim 2, wherein:
establishing said transaction start request between said customer device of said current customer and said sales system server of said merchant comprises:
comparing a location of said customer device with a merchant location of said merchant store,
verifying said customer device is in proximity of said merchant store,
notifying said SS application using said CD application of said customer device of a nearness of said merchant store and said customer device, and
establishing said transaction start request using said CD application of said customer device.

9. The method of use of claim 2, wherein:
establishing said transaction start request between said customer device of said current customer and said sales system server of said merchant comprises:
establishing A visual code comprising data associated with a location of said merchant store, a time data, and an encrypted key,
displaying said visual code on said point of sale system using said POS application,
reading said visual code with an optical reader of said customer device,
verifying a proximity of said customer device and said point of sale system using said SS application to match data in said visual code and said CD application, and
verifying an identify of said one or more consumers using said customer device.

10. The method of use of claim 2, further comprising:
an account setup method and a customer verification method;
said account setup method comprises for each said current customer among said one or more consumers:
creating unique credentials associated with said current customer,
collecting an identity verification database and a payment accounts database associated with said customer account of said current customer,
applying a jurisdiction regulations associated with said current customer to said customer account,
and associating one or more bio-verification markers with said current customer within said CD application; and
said customer verification method comprises for each among said current customer:
receiving a unique identifier associated with said current customer in said CD application,
creating said transaction start request associated with said current customer and said POS application,
sending said transaction start request to said SS application,
sending said synchronized copy to said one or more consumers to associated said current customer with said transaction data package, and
and verifying the identity of said current customer.

11. The method of use of claim 10, wherein:
verifying the identity of said current customer comprises biometric verification of said current customer with customer credentials stored on said customer device.

12. The method of use of claim 10, wherein:
verifying the identity of said current customer comprises biometric verification of said current customer with customer credentials stored on said customer device selected among: facial recognition, fingerprint verification, voice recognition, and government ID verification.

13. The method of use of claim 10, wherein:
said account setup method for each said current customer among said one or more consumers further comprises:
collecting copies of a government ID for said current customer,
collecting medical authorization or prescriptions for purchase of regulated goods under said jurisdiction regulations, and
verifying biometric data associated with said current customer for use in verifying an identify of said current customer for said transaction data package;
said customer verification method verifying said biometric data prior to creating said transaction data package,
Said method of use is further configured to pass portions of said jurisdiction regulations to said one or more consumers as said shopping limitations parameters to ensure regulatory compliance for a current transaction.

14. A method of use of a commercial transaction system for establishing a secure transaction between a point of sale system and a customer device and verifying the identity of a merchant and one or more consumers, comprising:
establishing a merchant account and merchant beacon ID with SS application associated with said merchant;
establishing a transaction start request between a transaction parties comprising said merchant and a current customer among said one or more consumers;
creating a transaction data package on said SS application of a sales system server comprising at least transaction ID, a shopping cart and a shopping limitations parameters;
sending a portion of said transaction data package to CD application on said customer device of said current customer and a POS application on said point of sale system of said merchant;
populating said shopping cart of said transaction data package using at least one among said CD application and said one or more consumers;
verifying an identity of the transaction parties using said transaction data package; and
completing a transaction between the transaction parties;
establishing said transaction start request between said customer device of said current customer and said sales system server of said merchant comprises:
comparing a location of said customer device with a merchant location of a merchant store,
verifying said customer device is in proximity of said merchant store,
notifying said SS application using said CD application of said customer device of a nearness of said merchant store and said customer device, and
establishing said transaction start request using said CD application of said customer device;
for each said current customer among said one or more consumers:
creating unique credentials associated with said current customer,
collecting an identity verification database and a payment accounts database associated with a customer account of said current customer,
applying a jurisdiction regulations associated with said current customer to said customer account,
and associating one or more bio-verification markers with said current customer within said CD application;
for each among said current customer:
receiving a unique identifier associated with said current customer in said CD application,
creating said transaction start request associated with said current customer and said POS application,
sending said transaction start request to said SS application,
sending a synchronized copy to said one or more consumers to associated said current customer with said transaction data package, and
and verifying the identity of said current customer.

15. The method of use of claim 10, wherein:
verifying the identity of said current customer comprises biometric verification of said current customer with customer credentials stored on said customer device.

16. The method of use of claim 10, wherein:
verifying the identity of said current customer comprises biometric verification of said current customer with customer credentials stored on said customer device selected among: facial recognition, fingerprint verification, voice recognition, and government ID verification.

17. The method of use of claim 10, wherein:
said account setup method for each said current customer among said one or more consumers further comprises:
collecting copies of a government ID for said current customer,
collecting medical authorization or prescriptions for purchase of regulated goods under said jurisdiction regulations, and
verifying biometric data associated with said current customer for use in verifying an identify of said current customer for said transaction data package;
said customer verification method verifying said biometric data prior to creating said transaction data package,
said method of use is further configured to pass portions of said jurisdiction regulations to said one or more consumers as said shopping limitations parameters to ensure regulatory compliance for a current transaction.
